(19) United States
(12) Patent Application Publication
(10) Pub. No.: US 2026/0014919 A1
(43) Pub. Date: Jan. 15, 2026

(54) PORTABLE LIFT ASSEMBLY

(71) Applicant: Roeslein Swiftlift, LLC, St. Louis, MO (US)

(72) Inventor: Trevor Donahoo, St. Louis, MO (US)

(21) Appl. No.: 18/770,012

(22) Filed: Jul. 11, 2024

(51) Int. Cl. B60P 1/44

(52) U.S. Cl. CPC B60P 1/4407

(57) ABSTRACT

A lift assembly is mounted to vehicle including a standard trailer hitch receiver. The lift assembly includes a coupler portion, a controller portion, and a support portion. The coupler portion is configured to securely couple the lift assembly to the vehicle. The control portion extends from the coupler portion. The support portion rotatably coupled to the coupler portion and including at least a first platform and a second platform extending from the first platform. Each of the first and second platforms is configured to support a load. The support portion is selectively moveable between a fully lowered position and a fully elevated position, wherein when in the fully lowered position, the first platform may contact the ground, and wherein when in the fully elevated position, said first platform is substantially perpendicular to the coupler portion.

### BACKGROUND

The field of the disclosure relates generally to hoist assemblies and, more particularly to hoist assemblies mounted on motor vehicles.

Hunting, including seeking, pursuing, and/or killing of game, has historically been a popular activity during pre-determined periods of the year. For example, recent surveys by the U.S. Fish and Wildlife Service estimate that at least 15% of the population hunts and that over 39 million hunting licenses were issued in 2023. Moreover, hunting is an activity that attracts a wide plethora of individuals, including those that may be feeble, aged, or disabled.

When hunting large game, such as deer or moose, for example, it is often desirable and necessary to dress a fallen or harvested animal while in the field. Field dressing a fallen animal enables the overall weight of the animal to be reduced for transportation, while decreasing the internal temperature of the harvested animal around any desirable meat, thus reducing the likelihood of bacteria growth and/or meat spoilage.

While field dressing is desirable, it also requires that the hunter elevate the fallen animal so that any exposed meat does not get soiled or contaminated during the dressing. Depending on the type of harvested game, the carcass can be quite heavy and awkward to move, especially if the hunter is feeble or disabled. As such, at least some known hunting equipment manufacturers have produced hoist assemblies that are able to couple to a motorized vehicle such that a fallen animal may be suspended from a vertical boom member. However, the use of known hoist assemblies may be limited by the type of vehicle being used. For example, some known hoist assemblies are designed to only be supported by a stanchion mounted to an All-Terrain Vehicle (ATV). At least some other known hoist assemblies are designed to only be supported by the tailgate of a pickup truck. Moreover, depending on the size of the fallen animal and where the animal was harvested, the boom and hoist assembly may need to disassembled and the animal removed from the hoist assembly in order to transport the field-dressed carcass. Such a process may also require a great deal of manual effort and/or dexterity.

Accordingly, it is desirable to have a portable hoist system that can be supported from any vehicle including a standard trailer hitch, whether the vehicle includes a tailgate or not, and that can be used to support and transport a field dressed animal without requiring the disassembly of the hoist assembly.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, these statements are to be read in this light, and not as admissions of prior art.

### BRIEF DESCRIPTION

In one aspect, a lift assembly for mounting to vehicle including a standard trailer hitch receiver is provided. The lift assembly includes a coupler portion, a controller portion, and a support portion. The coupler portion is configured to securely couple the lift assembly to the vehicle. The control portion extends from the coupler portion. The support portion rotatably coupled to the coupler portion and including at least a first platform and a second platform extending from the first platform. Each of the first and second platforms is configured to support a load. The support portion is selectively moveable between a fully lowered position and a fully elevated position, wherein when in the fully lowered position, the first platform may contact the ground, and wherein when in the fully elevated position, said first platform is substantially perpendicular to the coupler portion.

In another aspect, a portable lift assembly includes a coupler, a support portion, a support portion, and a drive mechanism. The coupler is sized to be received in a vehicle trailer hitch receiver. The support portion is rotatably coupled to the coupler and is configured to be selectively moveable from a first position to a second position. The support portion includes a first platform sized to receive a load thereon and a second platform extending substantially perpendicularly from the first platform and sized to receive a load thereon. At least one of the first and second platforms includes a frame and a screen securely coupled to the frame. The drive mechanism is coupled to the support portion and to the coupler for selectively moving the support portion between the first and second positions.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a right-side perspective view of an exemplary lift assembly coupled to a Utility Terrain Vehicle and in a fully elevated transport position.

FIG. 2 is a right-side perspective view of the lift assembly shown in FIG. 1 and in an intermediate position.

FIG. 3 is a left-side perspective view of the lift assembly shown in FIG. 1 and coupled to a pickup truck.

Like reference symbols in the various drawings are used to indicate like elements. The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in different environments without compromising any major functionality. In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The present embodiments may relate to, inter alia, lift systems that may be coupled to any vehicle that includes a standard trailer hitch. More specifically, the present embodiments enable a lift assembly to be securely supported by a standard trailer hitch, whether the vehicle includes a tailgate or not. As such, a harvested animal may be elevated a distance off the ground, field dressed while suspended off the ground, and transported from the location that the field dressing occurred to a base camp, for example. Alternatively, or additionally, the lift system is designed such that when fully elevated, the harvested carcass may be easily slid from the lift assembly, across a tailgate, and into the cargo bed or box portion of a vehicle. In the exemplary embodiment, the lift assembly uses a battery-powered winch assembly. In one embodiment, the lift assembly is integrated with a processor that is coupled to sensors within the lift assembly that enable the weight of anything placed on the lift assembly to be determined in real-time.

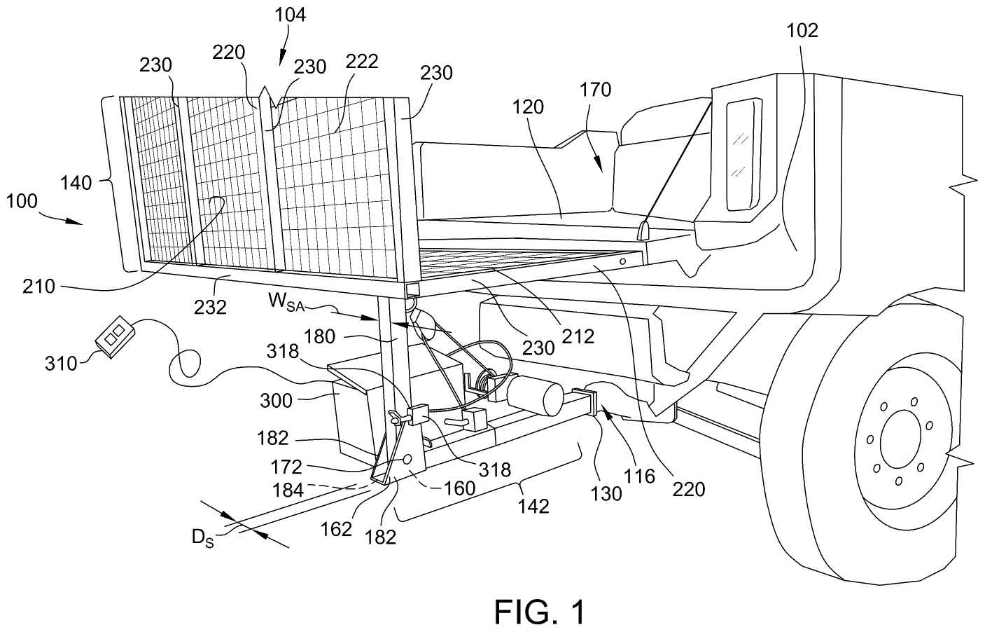

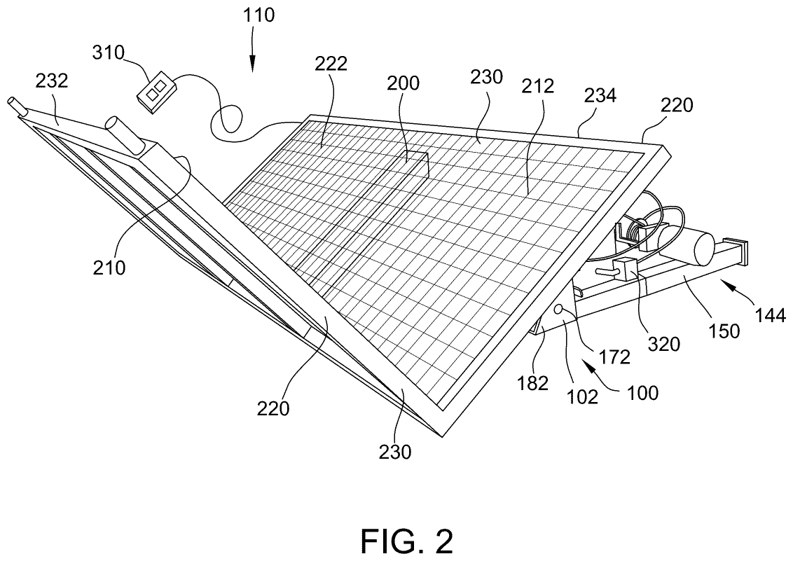

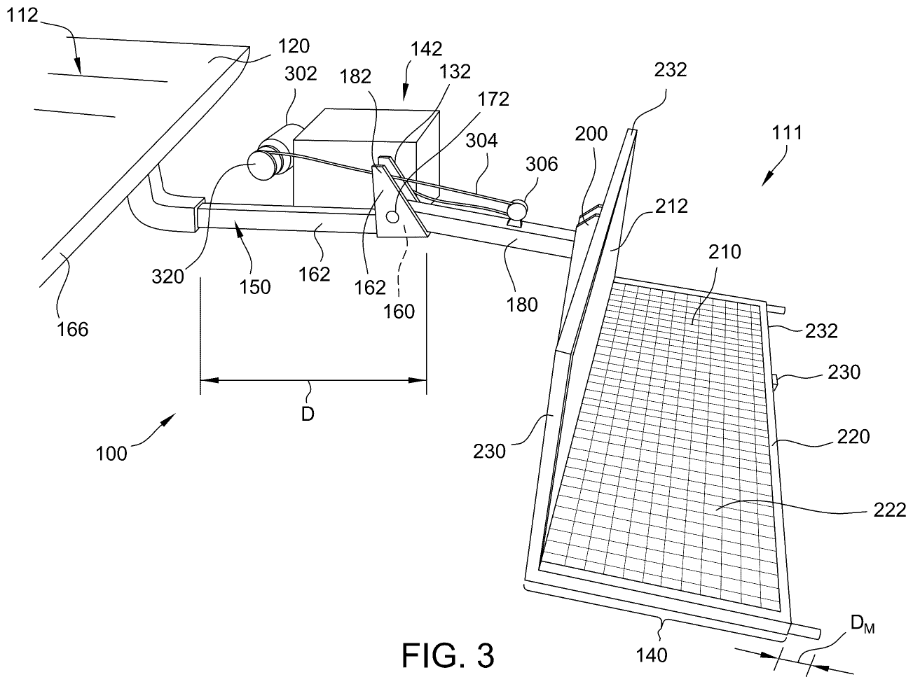

FIG. 1 is a right-side perspective view of an exemplary lift assembly 100 coupled to an exemplary Utility Terrain Vehicle (UTV) 102 and in a fully elevated transport position 104. FIG. 2 is a right-side perspective view of the lift assembly 100 and in an intermediate position 110, and FIG. 3 is a left-side perspective view of the lift assembly 100 in a fully lowered position 111 and coupled to an exemplary pickup truck 112. In the exemplary embodiment, the lift assembly 100, as described in more detail below, is configured to couple to any vehicle, such as UTV 102 and/or truck 112 that includes a standard trailer hitch 116, whether the vehicle 102 and/or truck 112, includes a tail gate 120 or not. Although a pickup truck 112 and a UTV 102 are illustrated, lift assembly 100 is not limited to being used only with such vehicles, and rather, any vehicle, such as, but not limited to Sport Utility Vehicles (SUV), All Terrain Vehicles (ATV), side-by-sides, Amphibious ATV (AATV), Off-Road Recreational Vehicles (ORV), snowmobiles, and/or any other vehicle that includes a standard trailer hitch that includes a standard receiver tube 130 that is formed with hitch pin openings (not shown). As such, in the exemplary embodiment, and as described in more detail below, the lift assembly 100 may be coupled to the vehicle without the use of bolts or any other permanent or semi-permanent fastening mechanisms. In some embodiments, the lift assembly 100 may be used with a receiver hitch (not shown).

In the exemplary embodiment, the lift assembly 100 includes a support portion 140, a control portion 142, and a coupler portion 144. More specifically, in the exemplary embodiment, the control portion 142 is between the coupler and support portion 144 and 140, respectively. The lift assembly 100 is coupled to the vehicle via the coupler portion 144. In the exemplary embodiment, the coupler portion 144 includes at least one receiver insert frame member 150 that is sized to be slidably inserted within a standard trailer hitch receiver tube 130. For example, in the exemplary embodiment, insert frame member 150 is sized to be slidably received in a 2″ hitch receiver. Alternatively, insert frame member 150 may be sized to be received within a 1.25″ hitch receiver, a 2.5″ hitch receiver, or a 3″ hitch receiver.

Insert frame member 150 includes at least one opening (not shown) formed therethrough that is sized to receive a standard hitch pin (not shown) therethrough. The hitch pin is inserted through the openings formed in the hitch receiver tube and through the openings formed in the insert frame member 150. The hitch pin securely couples the lift assembly 100 to the trailer hitch such that the insert frame member 150 is prevented from sliding out from the trailer hitch while the hitch pin is installed.

In the exemplary embodiment, receiver insert frame member 150 has a length measured from a first end (not shown) inserted within the trailer hitch receiver to a second end 160 that includes a pivot bracket 162. The length of the insert frame member 150 is variably selected to enable the pivot bracket 162 to be a pre-determined distance D from a rear end 166 of the vehicle. More specifically, the length of insert frame member 150 is selected to ensure that distance D enables the lift assembly support portion 140 to be selectively moved to the fully elevated transport position 104, as described herein, without support portion 140 contacting a tail gate 168 of the vehicle selected, when the tail gate 168 is open. As such, when the tail gate 168 of the vehicle is opened and lift assembly 100 is in the fully elevated transport position 140, a harvested carcass can be easily slid or moved from the lift assembly 100 into the cargo bed or box portion 170 of the vehicle. In the exemplary embodiment, insert frame member 150 is formed with multiple openings that enable the relative position (i.e., the insertion depth) of the insert frame member 150 within the hitch receiver to be variably selected. As such, by varying the insertion depth of frame member 150 within the hitch receiver, the distance D can be varied based on the vehicle that the lift assembly 100 is being coupled to. In an alternative embodiment, insert frame member 150 is formed with at least two telescoping members that enable the distance D to be variably selected.

. Alternatively, bracket 162 may be secured to frame member end 160 using any other coupling process that enables bracket 162 to be securely coupled to frame member end 160. In alternative embodiments, frame member 150 may include any other coupling mechanism that enables lift assembly support portion 140 and lift assembly 100 to function as described herein. In the exemplary embodiment, bracket 162 is formed with openings (not shown) that enable support portion 140 to be rotatably coupled to frame member 150 when a bolt or pin assembly 172, for example is inserted through the insert frame member openings and through a support portion arm 180. In the exemplary embodiment, in addition to coupling support portion to frame member 150, bracket 162, as described in more detail below, also limits rotation of support portion 140.

In the exemplary embodiment, pivot bracket 162 is formed with an opposed pair of guide sidewalls 182 that are coupled together along a lower sidewall 184 and along a forward stop wall (not shown). Pin assembly 172 extends through openings formed in sidewalls 182, and sidewalls 182 are spaced a distance Dₛ that is slightly wider than a width Wₛₐ of support portion arm 180. As such, in the exemplary embodiment, distance Dₛ enables support portion arm 180 to rotate between sidewalls 182 in a tight tolerance that facilitates reducing sway of support portion 140 as it is rotated to the fully elevated transport position 140, in particular, when support portion 140 is loaded. The forward stop wall of pivot bracket 162 extends between sidewalls 182 and facilitates stopping rotation of support portion 140 during rotation to the fully elevated transport position 140.

Support portion arm 180 extends from pivot bracket 162 to support portion 140. More specifically, arm 180 is pinned at a first end (not shown) to pivot bracket 162 and is rigidly secured to a main support spine member 200 that is coupled securely to support portion 140. In the exemplary embodiment, main support spine member 200 is secured with a plurality of mechanical fasteners (not shown) to support portion 140. In alternative embodiments, main support spine member 200 may be coupled with any other coupling means that enables spine member 200 and lift assembly 100 to function as described herein.

In the exemplary embodiment, support portion 140 includes a first platform 210 and a second platform 212. More specifically, in the exemplary embodiment, platforms 210 and 212 are formed integrally together such that the platform 210 extends substantially perpendicularly from platform 212. Moreover, in the exemplary embodiment, platforms 210 and 212 are substantially identical and each includes a screen 222 extending over and securely coupled to a support frame 220. In the exemplary embodiment, each screen 222 is fabricated from a metal material and is rigid. In alternative embodiments, at least one screen 222 is fabricated from a non-metallic material. In another embodiment, the screen 222 extending over platform 210 is not fabricated from the same material as the screen extending over platform 212.

In the exemplary embodiment, support frame 220 includes a plurality of lateral frame members 230 that are coupled at each end 232 to an outer longitudinal member 234. Each lateral frame member 230 is formed, in the exemplary embodiment, from a pair of members 230 that are securely coupled together, such as through a welding process, such that the members 230 are substantially perpendicular to each other and such that the each assembled lateral frame member 230 is generally L-shaped. Alternatively, lateral frame members 230 may be formed in any other shape that enables lift assembly 100 to function as described herein, such as, but not limited to semi-circular, V-shaped, and/or any other shape that enables lift assembly 100 to function as described herein. Moreover, in other alternative embodiments, members 230 may be formed from more or less than two members coupled together.

Longitudinal members 234, in the exemplary embodiment, provide structural support to each platform 210 and 212. More specifically, in the exemplary embodiment, members 234 are securely coupled to each lateral member 230 such that members 230 are spaced approximately equi-distant across each platform 210 and 212. For example, in the exemplary embodiment, members 230 are each welded to each member 234. Alternatively, members 230 may be securely coupled to each member 234 using any other known fastening mechanism that enables each platform 210 and 212 to function as described herein. As such, in the exemplary embodiment, each platform 210 and 212 includes four lateral members 230 that are each aligned substantially parallel to each other. In alternative embodiments, platforms 210 and/or 212 may have different shapes and/or sizes. Moreover, in other embodiments, each platform 210 and/or 212 may include more or less than four lateral members 230. Furthermore, in the exemplary embodiment, the lateral members 230 on the outer-most ends of platforms 210 and 212 each extend a distance Dm outwardly from the longitudinal member 234 on platform 212.

In the exemplary embodiment, members 230 and 234, as well as support portion arm 180 and frame member 150 are each fabricated from carbon steel square tubing. In alternative embodiments, any of members 230, 234, 150, and/or arm 180 may be fabricated from any other material and/or with any other shape that enables lift assembly 100 to function as described herein.

Screens 222 are securely coupled to members 234 and to members 230 to form platforms 210 and 212. In other embodiments, platforms 210 and 212 may include any other material that enables lift assembly 100 to function as described herein. In the exemplary embodiment, the open network provided by the screens 222 facilitates reducing the overall weight of the support portion 140 and provides a means for unwanted materials to fall through each platform 210 and 212, such as may be desirable when field dressing a harvested animal that is positioned on lift assembly 100.

In an alternative embodiment, platform 210 may be hingedly coupled to platform 212 to enable support portion 140 to be collapsible or folded for storage and for ease of transport. In such an embodiment, support portion 140 may include a locking mechanism (not shown) that prohibits the support portion 140 from folding unless the locking mechanism is removed.

In the exemplary embodiment, a storage box 300 is coupled adjacent to insert frame member 150. Moreover, in the exemplary embodiment, a winch 302 is coupled to the storage box 300. In the exemplary embodiment, the winch 302 is an electric winch that receives power from a lithium battery (not shown) stored in the storage box 300. Alternatively, any other type of winch, including but not limited to, a hydraulic winch, a capstan winch, and/or a hand-cranked manual winch, may be used, that enables lift assembly 100 to function as described herein. Furthermore, in alternative embodiments, any other type of hoisting mechanism that enables lift assembly 100 to function as described herein may be used. For example, in some alternative embodiments, a hoist, a windlass, a mechanical crane mechanism, a hydraulic mechanism, a derrick mechanism, and/or a capstand may be used to selectively move support portion 140 as described herein.

In the exemplary embodiment, the winch 302 uses wire cable 304 that is routed through a single pulley 306 coupled to support portion arm 180. Alternatively, the winch 302 may use any other cable, other than wire cable, that enables the winch 302 to function as described herein. In such an arrangement, the winch 302 achieves a mechanical advantage of about 2:1 and enables the lift assembly 100 to elevate and lift between about 200 to about 350 lbs on the support portion 140. In alternative embodiments, lift assembly 100 may include additional pullies to facilitate increasing the mechanical advantage gained to about 4:1, 6:1 or to at least 10:1, for example, to facilitate increasing the rotational speed during lifting of lift assembly 100, and/or to facilitate increasing the maximum loading capability of lift assembly 100.

In addition, in the exemplary embodiment, the winch 302 includes an automatic brake that facilitates increased safety of the lift assembly 100. More specifically, in the exemplary embodiment, the winch automatically holds the weight as the support portion 140 is being raised and lowered thus preventing the hoisted load from falling suddenly.

In the exemplary embodiment, the winch 302 is coupled to a battery secured in the storage box. Alternatively, other types of batteries or power sources may be used to power the winch 302. Moreover, in other embodiments, the winch may be coupled to a vehicle battery and/or be powered from the vehicle. In addition, in the exemplary embodiment, a hand-held controller 310 is coupled to the winch 302 through an interface (not shown) mounted in the storage box 300. More specifically, the hand-held controller 310 enables a user, i.e., a disabled individual hunting, to control operation of the winch 302. In other embodiments, the hand-held controller 310 is wirelessly coupled to the winch 302. In some embodiments, the storage box 300 also contains a processor that enables a loading weight of the support portion 140 to be determined in real time prior to activation of the winch 302. In such an embodiment, the processor receives inputs from various sensors coupled to the lift assembly 100. Moreover, in such an embodiment, the processor may also determine the relative position of the support portion 140 and the loading induced to the winch 302 from the support portion 140.

In the exemplary embodiment, the lift assembly 100 also includes a proximity kill switch 318 that automatically shuts off operation of the winch 302 when the support portion 140 has reached the fully elevated position 104. Moreover, in the exemplary embodiment, the kill switch 318 also supplies an input to the processor. In addition, in the exemplary embodiment, the processor continuously monitors loading on the winch 302 and will disengage operation of the winch 302 is the loading exceeds a pre-determined threshold.

During use, after an animal has been killed, for example, a user can maneuver the vehicle 102 into close proximity to the fallen animal. Using the hand-held controller 310, the support portion 140 can be lowered to fully lowered position 111 such that the support portion 140 contacts the ground adjacent to the animal to be harvested. After the carcass is slid onto the lowest screened platform 210, the user can raise the support portion 140 to the intermediate position 110. When in the intermediate position, the carcass can be field dressed such that any undesired materials will fall through the screens 222 and such that any exposed meat does not get soiled or contaminated during the field dressing. Because the height of the lift assembly in the intermediate position off the ground is relatively shorter, as compared to the height of other devices used for field dressing an animal, a disabled or wheelchair bound hunter can still reach the carcass to perform field dressing. When field dressing is complete and transport of the carcass is desired, the lift assembly 100 can be further elevated to the fully elevated position 104 and the carcass can remain in the support portion 140 and/or be easily slid from the lift assembly 100 into the cargo bed 170 of the vehicle.

More specifically, when the lift assembly 100 is activated to selectively move the support portion 140 from the fully lowered position 111 to the fully elevated position 104, the winch begins to draw the cable 304 about the winch drum 320. As the cable 304 is wound about the drum 320, the winch pulling force causes support portion arm 180 to rotate about pin assembly 172 and to elevate support portion 140. Continued operation of the winch 302 forces support portion arm 180 to slide between pivot bracket guide sidewalls 182 which provide structural support to facilitate reducing sway and/wobble of support portion arm 180 and support portion 140. Operation of the winch 302 continues until the support portion 140 is in the fully elevated position 104 and platform 212 is adjacent to the tailgate 120 of the vehicle. In some embodiments, when lift assembly 100 is in the fully elevated position 104, the support portion platform 212 is generally co-planar with an upper surface 324 of the tailgate 120 such that movement of the carcass from the lift assembly 100 into the cargo bed 170 may be relatively easily accomplished via sliding or dragging the carcass.

In some embodiments, the operational range and capabilities of the lift assembly 100 can be implemented or changed using computer programming or engineering techniques including computer software, firmware, hardware, or any combination or subset thereof. As such, changes or updates to the lift assembly operation, because of future developments, for example, may be easily performed.

In addition, it should be noted that during a field dressing process, a user may couple spreader bars to the carcass to facilitate the field dressing while the carcass is suspended via the lift assembly. Moreover, it should also be noted that in some embodiments, the cable on the winch assembly can be extended to at least fifty feet to facilitate retrieving and/or movement of a carcass closer to the vehicle.

As disclosed above, there is a need for a lift assembly that enables the safe coordinated movement of a carcass to a position that the carcass can be easily field dressed, even by a disabled or wheelchair bound user. The systems described herein provide a vehicle-mounted lift assembly that be easily coupled to a standard trailer hitch receiver without the use of any non-standard trailer hitch hardware. Moreover, the lift assembly includes the following combination of desirable features: (i) it is as easily adapted to be used on motor vehicles that include a cargo bed and a tailgate, as it is on motor vehicles that do not include a cargo bed and/or a tailgate; (ii) it is easily lowered to the ground to enable a harvested animal to be easily slid into the lift apparatus; (iii) it is easily elevated to a position that enables field dressing to occur at an elevated height that reduces the likelihood of usable meat being inadvertently soiled and/or contaminated during the field dressing; (iii) is easily elevated to a position that field dressing can be performed by a disabled individual and/or an individual that is wheelchair bound; and (iv) it is easily elevated to a position that enables the carcass to be easily slid from the lift apparatus into a cargo bed of a vehicle for transportation.

Exemplary embodiments of lift assemblies are described above in detail. The systems of this disclosure though, are not limited to only the specific embodiments described herein, but rather, the components and/or methods of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

This written description uses examples to disclose various implementations, including the best mode, and also to enable any person skilled in the art to practice the various implementations, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A lift assembly for mounting to vehicle including a standard trailer hitch receiver, said lift assembly comprising:
a coupler portion configured to securely couple said lift assembly to the vehicle;
a control portion extending from said coupler portion; and
a support portion rotatably coupled to said coupler portion and comprising at least a first platform and a second platform extending from the first platform, each of said first and second platforms is configured to support a load, said support portion selectively moveable between a fully lowered position and a fully elevated position, wherein when in the fully lowered position, said first platform may contact the ground and wherein when in the fully elevated position, said first platform is substantially perpendicular to said coupler portion.

2. The lift assembly in accordance with claim 1 further comprising a winch assembly coupled to said support portion for selectively rotating said support portion between said fully lowered and fully elevated positions.

3. The lift assembly in accordance with claim 2 wherein said winch assembly is electric.

4. The lift assembly in accordance with claim 2 wherein said winch is capable of lifting at least 350 pounds positioned within said support portion.

5. The lift assembly in accordance with claim 2 wherein when the support portion is rotated to a fully elevated position, the second platform is substantially coplanar with a cargo bed of the vehicle.

6. The lift assembly in accordance with claim 5 wherein when the support portion is rotated to a fully elevated position, the second platform does not contact an open tailgate extending from the vehicle.

7. The lift assembly in accordance with claim 2 wherein at least one of the first platform and the second platform is formed from a rigid screen.

8. The lift assembly in accordance with claim 2 wherein the support portion is selectively movable to any relative position between the fully lowered and fully elevated positions.

9. A portable lift assembly comprising:
a coupler sized to be received in a vehicle trailer hitch receiver;
a support portion rotatably coupled to said coupler and configured to be selectively moveable from a first position to a second position, said support portion comprising a first platform sized to receive a load thereon and a second platform extending substantially perpendicularly from said first platform and sized to receive a load thereon, at least one of said first and second platforms comprises a frame and a screen securely coupled to said frame; and
a drive mechanism coupled to said support portion and to said coupler for selectively moving said support portion between said first and second positions.

10. The portable lift assembly in accordance with claim 9 wherein said coupler is removably coupled within the vehicle trailer hitch receiver.

11. The portable lift assembly in accordance with claim 9 wherein said drive mechanism is a winch assembly.

12. The portable lift assembly in accordance with claim 11 wherein the winch assembly is electrically powered, said portable lift assembly further comprises a storage box sized to receive a battery therein for powering said winch assembly.

13. The portable lift assembly in accordance with claim 12 further comprising a hand-held controller configured to operate the winch assembly from a distance away from the lift assembly.

14. The portable lift assembly in accordance with claim 9 wherein said second platform is generally parallel to said coupler when said support portion is in the second position, and wherein said second platform is generally perpendicular to said coupler when said support portion is in the first position.

15. The portable lift assembly in accordance with claim 9 wherein each of said first and second platforms comprises a frame and a screen securely coupled to said frame.

16. The portable lift assembly in accordance with claim 15 wherein said first platform screen is fabricated from a different material than said second platform screen.

17. The portable lift assembly in accordance with claim 9 wherein said first platform is hingedly coupled to said second platform such that said first platform is selectively foldable against said second platform.

18. The portable lift assembly in accordance with claim 9 further comprising a stop configured to prevent rotation of said support portion.
